(19) United States
(12) Patent Application Publication
(10) Pub. No.: US 2024/0038061 A1
(43) Pub. Date: Feb. 1, 2024

(54) INFORMATION ANALYSIS DEVICE AND INFORMATION ANALYSIS METHOD

(71) Applicant: HONDA MOTOR CO., LTD., Tokyo (JP)

(72) Inventor: Yoshiaki SUGIMOTO, Tokyo (JP)

(21) Appl. No.: 18/258,213

(22) PCT Filed: Dec. 9, 2021
(86) PCT No.: PCT/JP2021/045293

§ 371 Date: Jun. 19, 2023

(30) Foreign Application Priority Data
Dec. 22, 2020 (JP) 2020-212236

(51) Int. Cl. G08G 1/01

(52) U.S. Cl. CPC G08G 1/0129

(57) ABSTRACT

The present invention performs analysis based on information such as position information relating to movable bodies. The present invention is provided with: a movable body management unit that accumulates history of the total number of a plurality of movable bodies and position information received from the movable bodies; a map information storage unit that stores map information including the position of a road along which the plurality of movable bodies can pass; a road position designation unit that receives designation of a road position in the map information by a user; and a seasonal fluctuation value calculation unit that calculates, regarding the designated road position, a vehicle number increase/decrease correction value in a predetermined period from the history of the total number of the movable body management units, and calculates, while taking into account the vehicle number increase/decrease correction value, a seasonal fluctuation value of the number of the movable bodies passing along the road position from the position information relating to the plurality of movable bodies.

### TECHNICAL FIELD

The present invention relates to an information analysis device and an information analysis method for information analysis regarding movable bodies.

### BACKGROUND ART

Conventionally, techniques have been known that acquire position information of movable bodies such as automobiles, and use the acquired position information. Position information indicates information including at least a time (date and time information) at which a position was measured.

For example, when opening a new store, there is a need to predict the sales of the store when opening the store at the scheduled location. To that end, techniques have been conventionally known that predict the number of visitors and the sales by measuring the number of vehicles that pass the vicinity of the scheduled store location in one day, visually and using measuring equipment. Patent Document 1 discloses an information analysis device that predicts a total traffic volume on a road, calculates a correlation between customer visits to a facility along the road and the total traffic volume on the basis of data regarding customer visits to the facility and, on the basis of the calculated correlation, predicts sales of a new store to be opened or other stores.
Patent Document 1: PCT International Publication No. WO2019/059137

### DISCLOSURE OF THE INVENTION

### Problems to be Solved by the Invention

However, in methods which measure the number of passing vehicles visually and using measuring equipment, measuring is limited to a short time, at most a few days, due to expenses and available installation space. Therefore, in regions where the number of passing vehicles varies depending on the season, calculating the correlation as described above and applying the correlation to a different season than the season in which the correlation was calculated would sometimes lead to a significant error in the sales predicted from the number of passing vehicles using the correlation. Further, in the technique described in Patent Document 1, the number of vehicles provided with communication equipment and capable of uploading position information (also referred to as “probe vehicles” below) is limited, and the number of probe vehicles constantly varies according to, for example, the trading patterns of probe vehicles. Therefore, the technique described in Patent Document 1 has been unable to visualize the variation in number of passing vehicles by season, for example.

It is thus an object of the present invention to provide an information analysis device and an information analysis method capable of precisely ascertaining the visits and the sales of a store depending on the season, on the basis of position information received from a plurality of vehicles.

### Means for Solving the Problems

(1) An information analysis device (for example, the information analysis device 30 described below) according to the present invention includes: a movable body manager (for example, the movable body manager 311 described below) configured to accumulate a history of a total number of a plurality of movable bodies and position information received from the movable bodies; a map information storage (for example, the storage 32 described below) configured to store map information including a position of a road along which the plurality of movable bodies can pass; a road position designator (for example, the road position designator 312 described below) configured to accept a designation of a road position in the map information by a user; and a seasonal variation value calculator (for example, the seasonal variation value calculator 313 described below) configured to calculate, regarding the designated road position, a vehicle number increase/decrease correction value in a predetermined period from the history of the total number of the movable body manager, and calculate a seasonal variation value of the number of the movable bodies passing the road position, from the position information relating to the plurality of movable bodies, while taking into account the vehicle number increase/decrease correction value.

According to (1), a variation in visits and sales of a store can be precisely ascertained, by calculating a seasonal variation value of traffic at a predetermined road position, while taking into account an increase or a decrease of probe vehicles.

(2) The information analysis device according to (1) may be configured such that the seasonal variation value calculator calculates the seasonal variation value of the number of the movable bodies by correcting the position information of the movable bodies using a standard score.

According to (2), a variation in visits and sales of a store can be precisely ascertained, by calculating a seasonal variation value of traffic at a predetermined road position.

The information analysis device according to (1) or (2) may further includes a visit data storage configured to store data regarding customer visits to a facility corresponding to the designated road position, wherein the seasonal variation value calculator calculates a correlation regarding the customer visits to the facility or sales, using the data regarding the customer visits.

According to (3), the number of visits to a facility or sales can be calculated.

(4) The information analysis device according to any one of (1) to (3) may be configured such that the seasonal variation value calculator calculates the seasonal variation value based on a unit of a predetermined period including a weekday and a holiday.

According to the fourth aspect, sales can be predicted without being affected by variations between weekdays and holidays.

(5) An information analysis method according to the present invention is an information analysis method executed by a computer, the information analysis method includes: a movable body management step of accumulating a history of the total number of a plurality of movable bodies and position information received from the movable bodies; a map information storage step of storing map information including a position of a road along which the plurality of movable bodies can pass; a road position designation step of accepting a designation of a road position in the map information by a user; and a seasonal variation value calculation step of calculating, regarding the road position designated, a vehicle number increase/decrease correction value in a predetermined period from the history of the total number of the movable body management step, and calculating a seasonal variation value of the number of the movable bodies passing the road position, from the position information relating to the plurality of movable bodies, by taking into account the vehicle number increase/decrease correction value.

According to (5), a variation in visits and sales of a store can be precisely ascertained, by calculating a seasonal variation value of traffic at a predetermined road position.

(6) The information analysis method according to (5) may further include a visit data storage step of storing data regarding customer visits to a facility corresponding to the designated road position, wherein the seasonal variation value calculation step includes calculating a correlation regarding the customer visits to the facility or sales, using the data regarding the customer visits.

According to (6), the information analysis method exhibits similar effects as the information analysis device according to (3).

(7) The information analysis device according to (5) or (6) may be configured such that the seasonal variation value calculation step of calculating the seasonal variation value based on a unit of a predetermined period including a weekday and a holiday.

According to (7), the information analysis method exhibits the same effect as the information analysis device according to (4).

### Effects of the Invention

According to the present invention, the visits and the sales of a store depending on the season can be precisely ascertained, on the basis of position information received from a plurality of vehicles.

### BRIEF DESCRIPTION OF THE DRAWINGS

FIG. 1 is a block diagram illustrating the basic structure of the entirety of an information analysis system according to an embodiment of the present invention;

FIG. 2 is a functional block diagram illustrating the functional structure of an on-board navigation device according to an embodiment of the present invention

FIG. 3 is a functional block diagram illustrating the functional structure of a portable terminal according to an embodiment of the present invention;

FIG. 4 is a functional block diagram illustrating the functional structure of an information analysis device according to an embodiment of the present invention;

FIG. 5 illustrates an example of a position information database according to an embodiment of the present invention;

FIG. 6 illustrates an example of total vehicle number history data according to an embodiment of the present invention;

FIG. 7 illustrates an example explaining variations in the total number of vehicles according to an embodiment of the present invention;

FIG. 8 illustrates an example of variations in the number of vehicles in which the on-board navigation device and the portable terminal are used according to an embodiment of the present invention;

FIG. 9A illustrates an example of a graph comparing the variations in the total number of vehicles according to an embodiment of the present invention;

FIG. 9B illustrates an example of a graph of a Z value according to an embodiment of the present invention;

FIG. 10 is a functional block diagram illustrating the functional structure of an analysis information reference device according to an embodiment of the present invention;

FIG. 11 illustrates an example of a display of a Z value and a corrected traffic volume for roads corresponding to each of two stores according to an embodiment of the present invention;

FIG. 12 is a flowchart illustrating a basic operation of performing an updating process of the position information database according to an embodiment of the present invention; and

FIG. 13 is a flowchart illustrating a basic operation of performing an analysis process according to an embodiment of the present invention.

### PREFERRED MODE FOR CARRYING OUT THE INVENTION

A preferred embodiment of an information analysis system according to the present invention will be described below with reference to the drawings.

### <Overall Structure of Information Analysis System 1>

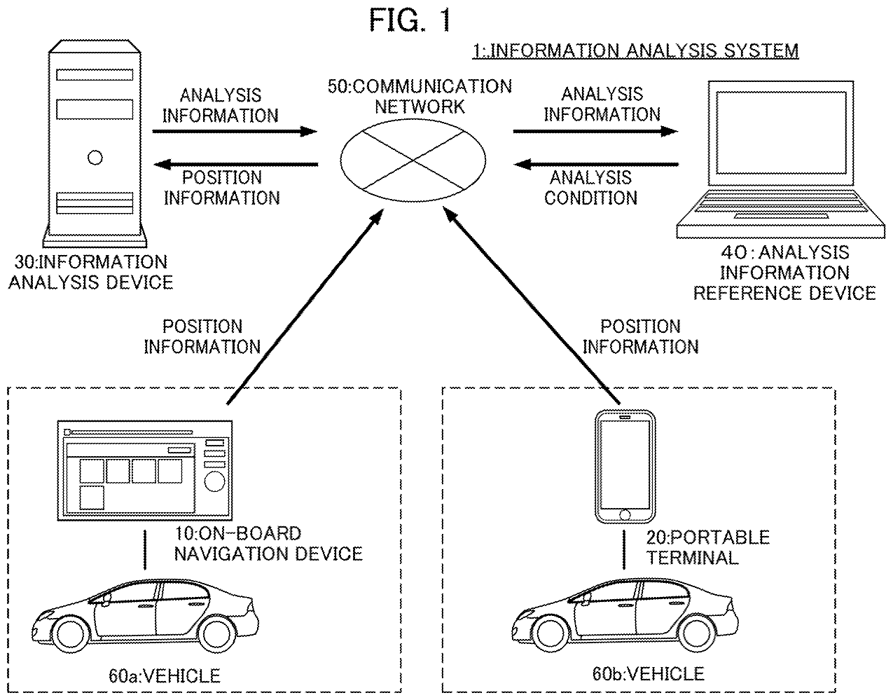

An information analysis system 1 according to a preferred embodiment of the present invention is described. FIG. 1 illustrates the overall structure of the information analysis system 1.

As illustrated in FIG. 1, the information analysis system 1 includes an on-board navigation device 10, a portable terminal 20, an information analysis device 30, and an analysis information reference device 40. The respective devices and respective terminals are communicably connected to each other via a communication network 50. It should be noted that, while information transmitted and received by these devices and terminals is illustrated in the drawing, this information is merely an example. In the present embodiment, information other than that illustrated may be transmitted and received.

The on-board navigation device 10 is a device that performs navigation (route guidance) with respect to a user in a vehicle 60a. The on-board navigation device 10 performs route guidance from a current position to a destination, on the basis of a request by the user. The on-board navigation device 10 also has a function of measuring position information of the on-board navigation device 10 (that is, position information of the vehicle 60a). The position information measured by the on-board navigation device 10 is appropriately transmitted to the information analysis device 30.

The on-board navigation device 10 may be realized by a car navigation device that is provided in the vehicle 60a that is a movable body, or a portable navigation device (PND) that is simply provided in the vehicle 60a that is a movable body.

The portable terminal 20 is a portable terminal used by a user in a vehicle 60b. The portable terminal 20 has a function of measuring position information of the portable terminal 20 (that is, position information of the vehicle 60b), like the on-board navigation device 10. The position information measured by the portable terminal 20 is appropriately transmitted to the information analysis device 30, similarly to the position information measured by the on-board navigation device 10.

The portable terminal 20 can be realized by a smart phone, a mobile phone, a tablet terminal, a laptop computer, and other portable electronic devices.

It should be noted that, while the drawing illustrates one of each of a set of an on-board navigation device 10 and a vehicle 60a and a set of a portable terminal 20 and a vehicle 60b, there is no particular limit to the number of these sets. In addition, in the below description, when not making any distinction between the vehicle 60a in which the on-board navigation device 10 is installed and the vehicle 60b driven by the user of the portable terminal 20, the alphabetic characters at the end are omitted, and the vehicle is referred to simply as “vehicle 60”.

The information analysis device 30 is a device that performs an analysis based on various information such as the position information of each of the vehicles 60 that are movable bodies, as a process specific to the present embodiment. Specifically, the information analysis device 30 creates a position information database that is a database of position information of each vehicle 60 for each date and time of movement, by acquiring the position information of each vehicle 60 from the on-board navigation device 10 and the portable terminal 20 for each date and time of movement. In addition, the information analysis device 30 stores map information including the positions of roads on which each vehicle 60 can travel.

Then, on the basis of the position information of each vehicle 60 and the map information, the information analysis device 30 calculates a total number of vehicles 60 on a road during, for example, a predetermined period unit. In addition, the information analysis device 30 stores data regarding customer visits to a facility such as a store. Further, on the basis of the calculated total number of vehicles 60 and the stored data regarding customer visits to the facility, the information analysis device 30 calculates a correlation between the customer visits to the facility and the total number of vehicles 60 according to seasonal variations.

In this way, the information analysis device 30 is able to perform analysis according to seasonal variations on the basis of information such as the position information acquired from the vehicles 60 that are movable bodies. In addition, the information analysis device 30 provides the information such as on the correlation according to seasonal variations calculated in this way to a user, as analysis information according to seasonal variations.

The user may use this analysis information for a variety of applications. For example, the user is able to perform an analysis on the basis of the correlation between a traffic volume, and the sales amount of a store and a number of visitors and a number of visits by movable bodies to a store according to seasonal variations. In addition, by using the analysis information, the sales amount of the store, the number of visitors and the number of visits by movable bodies to the store according to seasonal variations can be predicted.

In this case, the user may be a business operator who is considering opening a new store, or a consultant who is providing consulting services to the business operator. In other words, the analysis information according to the present embodiment may be used by a variety of users.

A specific usage method of the analysis information is described in the section labeled <Example of use by user of display corresponding to analysis information>.

The analysis information reference device 40 is a terminal that is operated by a user using the analysis information. In order to obtain analysis information according to a desired condition, the user using the analysis information inputs a desired analysis condition into the analysis information reference device 40. The analysis information reference device 40 transmits the input analysis condition to the information analysis device 30. The information analysis device 30 generates analysis information corresponding to the received analysis condition, and returns the analysis information to the analysis information reference device 40.

Then, the analysis information reference device 40 outputs the returned analysis information to the user using the analysis information. The user can thus obtain analysis information according to a desired analysis condition. Here, the analysis condition is a condition including a designation of a store to be analyzed in order to generate the analysis information, etc. The details of the analysis condition will be described later.

Such an information analysis device 30 and analysis information reference device 40 can be realized by incorporating software for realizing the present embodiment in, for example, a server device or a personal computer.

The communication network 50 is realized by a network such as the Internet and a mobile phone network, and a network combining these. In addition, part of the network (for example, between the information analysis device 30 and the analysis information reference device 40) may include a local area network (LAN).

The vehicle 60 is a movable body having the on-board navigation device 10 or a user of a portable terminal 20. The vehicle 60 is realized by, for example, a four-wheeled automobile, a two-wheeled motorcycle, a bicycle, etc.

### <Functional Blocks of On-Board Navigation Device 10>

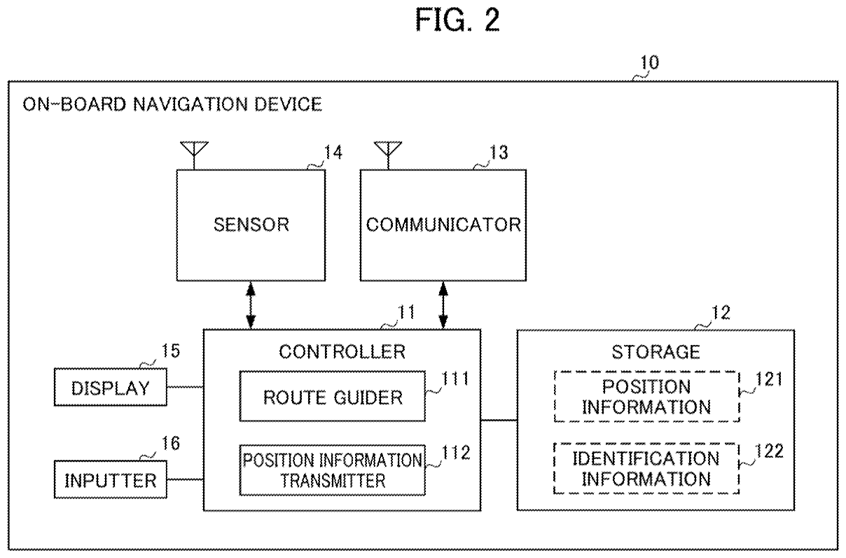

Next, the functional blocks of the on-board navigation device 10 will be described with reference to the block diagram of FIG. 2.

Here, the on-board navigation device 10 is supplied with power from the vehicle 60a, and is automatically activated when the ignition switch of the vehicle 60a is turned on (the engine is started) by the user driving the vehicle 60a. The on-board navigation device 10 remains in operation until the ignition switch of the vehicle 60a is turned off (the engine is stopped) by the user driving the vehicle 60a.

As illustrated in FIG. 2, the on-board navigation device 10 includes a controller 11, a storage 12, a communicator 13, a sensor 14, a display 15, and an inputter 16.

The controller 11 is constituted by a processing device such as a microprocessor, and controls each component constituting the on-board navigation device 10. The details of the controller 11 will be described later.

The storage 12 is constituted by semiconductor memory or the like, and stores various programs such as a control program called firmware or an operating system, a program for performing a route guiding process, and a program for performing a transmission process of position information to the information analysis device 30, and further stores various kinds of information such as map information, etc. The drawing illustrates, as information stored by the storage 12, position information 121 and movable body identification information 122, which are particularly related to the transmission process of the position information.

The position information 121 is position information of the on-board navigation device 10 (in other words, position information of the vehicle 60a) measured by the sensor 14 described later. The position information 121 is configured to include not only information indicating a measured position, but also the time at which measuring was performed (date and time information).

In addition, the movable body identification information 122 is information for identifying the on-board navigation device 10. For example, a serial number or the like which is uniquely assigned to the on-board navigation device 10 may be used as the movable body identification information 122. In addition, it is also possible to use, as the movable body identification information 122, a telephone number given to a subscriber identity module (SIM) inserted into the communicator 13 to allow the communicator 13 to connect to the communication network 50, which is a network such as a mobile phone network. In addition, it is also possible to use, as the movable body identification information 122, a unique vehicle identification number (VIN) given to the vehicle 60a, or the license number.

The various kinds of information stored in the storage 12 may be stored in the storage 12 in advance, or downloaded as necessary from a server device (not illustrated) or the like connected to the communication network 50. Further, the information may be modified as necessary in response to an input from the user, etc.

The communicator 13 has a digital signal processor (DSP), and realizes wireless communication with other devices (for example, the information analysis device 30) connected to the communication network 50 according to standards such as Long Term Evolution (LTE), 4th Generation (4G), 5th generation (5G), or Wi-Fi®. The communicator 13 is used, for example, to allow a position information transmitter 112 described later to transmit the position information 121 and the movable body identification information 122 stored in the storage 12 to the information analysis device 30. However, there is no particular limitation on data transmitted and received between the communicator 13 and other devices, and information other than the position information 121 and the movable body identification information 122 may be transmitted and received.

The sensor 14 is constituted by, for example, a global positioning system (GPS) sensor, a gyro sensor, an acceleration sensor, etc. The sensor 14 has a function as a position detection unit that detects position information, receives a GPS satellite signal by the GPS sensor, and measures the position information (latitude and longitude) of the on-board navigation device 10. Measuring by the sensor 14 is performed as described above at a predetermined time interval (for example, every three seconds). The measured position information is stored in the storage 12 as position information 121.

In addition, the sensor 14 is capable of further increasing the measuring accuracy of the position information of the on-board navigation device 10 on the basis of an angular velocity and an acceleration measured by the gyro sensor and the acceleration sensor.

In addition, when GPS communication is difficult or impossible, the sensor 14 can use assisted global positioning system (AGPS) communication to calculate the position information of the on-board navigation device 10 by means of base station information acquired from the communicator 13.

The display 15 is constituted by a display device such as a liquid crystal display or an organic electroluminescent panel, etc. The display 15 displays an image upon receiving an instruction from the controller 11. Information displayed by the display 15 may include, for example, the current position of the on-board navigation device 10, map information nearby the current position of the on-board navigation device 10 which is read out from the map information, a destination set by the user, appointment information notified from another on-board navigation device 10, route information, and various user interfaces, etc.

The inputter 16 is constituted by an input device (not shown) such as a physical switch called a ten key, or a touch panel provided in a state of being superimposed on a display surface of the display unit 15. An operation such as a selection operation by the user and enlargement or reduction of a map can be performed by outputting, to the controller 11, a signal, based on an operation input from the inputter 16, for example, pressing of the ten key or touching on the touch panel by the user.

It should be noted that, although not illustrated in the drawings, a speaker and a microphone may be provided. The speaker outputs a voice to a driver, and the microphone collects a voice or the like uttered by the driver.

This allows for information to be output as a voice from the speaker, and for various selections and instructions to be input as a voice by the driver through the microphone to be input into the controller 11 by voice recognition technology.

Next, the details of the controller 11 will be described. The controller 11 is constituted by a microprocessor having a central processing unit (CPU), a random-access memory (RAN), a read-only memory (ROM), an input/output (I/O), and the like. The CPU executes each program read out from the ROM or the storage 12, reads out information from the RAM, the ROM, and the storage 12 in execution of the program, writes the information in the RAM and the storage 12, and transmits and receives a signal to and from the communicator 13, the sensor 14, the display 15, and the inputter 16. Thus, the process of the present embodiment is realized by hardware and software (programs) cooperating in this way.

The controller 11 includes as a functional block a route guider 111 and a position information transmitter 112.

The route guider 111 is a section that performs a route guiding process to a destination such as a facility, etc. input or selected by the user.

The route guiding process to the destination is equivalent to a route guiding process in general car navigation systems. That is to say, the route guider 111 can perform route guiding by generating a map to the destination on the basis of the map information (not illustrated) stored in the storage 12, superimposing the current position of the on-board navigation device 10 measured by the sensor 14, the position of the destination, and route information to the destination on this map, and displaying this on the display 15. In this case, a voice for the route guiding may further be output from the speaker not illustrated in the drawings. In addition, information on traffic congestion of a road and information on the weather may be acquired through communication by the communicator 13, and the acquired information may be used in the route guiding process.

The route guiding process to the destination is well known to those skilled in the art and, therefore, further detailed description thereof is omitted. In addition, the map information for performing the route guiding process is also well known to those skilled in the art, and therefore further detailed description and illustration thereof is omitted.

The position information transmitter 112 is a unit that transmits the position information 121 and the movable body identification information 122 stored in the storage 12 to the information analysis device 30 through wireless communication using the communicator 13.

Transmission of the position information 121 and the movable body identification information 122 to the information analysis device 30 by the position information transmitter 112 is performed periodically, from when the ignition switch of the vehicle 60a is turned on (the engine is started) by the user of the vehicle 60a and the on-board navigation device 10 is automatically activated, until when the ignition switch of the vehicle 60a is turned off (the engine is stopped). Transmission is performed in real time, for example, whenever the sensor 14 performs a measurement at a predetermined interval (for example, every three seconds). Alternatively, instead of transmitting to the information analysis device 30 in real time, a plurality of pieces of information (for example, the position information 121 and the movable body identification information 122 updated every three seconds for a three-minute period) may be transmitted at a time. That is to say, so-called burst transmission is possible. The length of the predetermined time interval, and whether to transmit in real time or with burst transmission, may be freely set according to the environment to which the present embodiment is to be applied.

By performing real-time transmission or burst transmission in this way, the position information transmitter 112 transmits the position information 121 for identifying a movement route of the vehicle 60a measured by the sensor 14 and the movable body identification information 122 to the information analysis device 30.

In this case, a position that is identified by the position information 121 measured immediately after the ignition switch has been turned on (the engine has been started) and the on-board navigation device 10 has automatically activated can be transmitted to the information analysis device 30 as an initial vehicle position, in other words, a departure position. Further, a position that is identified by the position information 121 measured immediately before the ignition switch is turned off (the engine is stopped) can be transmitted to the information analysis device 30 as a final vehicle position, in other words, a parking position.

In this case, activation information indicating that the position information 121 represents the departure position and stopping information indicating that the position information 121 represents the parking position may be added to the position information 121 before transmission to the information analysis device 30. For example, transmission may be performed with a flag indicating activation information set to 1 and a flag indicating stopping information set to 1. Moreover, the position information 121 (in other words, the parking position) measured immediately before the ignition switch is turned off (the engine is stopped) may be transmitted when the ignition switch is turned on (the engine is started) and the on-board navigation device 10 is re-activated.

In addition, even in a case of performing burst transmission, if it has been determined by the route guider 111 that the vehicle 60a has arrived at the destination (for example, a certain facility), the position information transmitter 112 may switch to real-time transmission. By doing this, it is possible to prevent a situation where, after arriving at a certain facility, the ignition switch is turned off (the engine is stopped) before the position information 121 of the parking position is transmitted and the position information 121 of the destination such as the facility, etc. has not been transmitted to the information analysis device 30.

### <Functional Blocks of Portable Terminal 20>

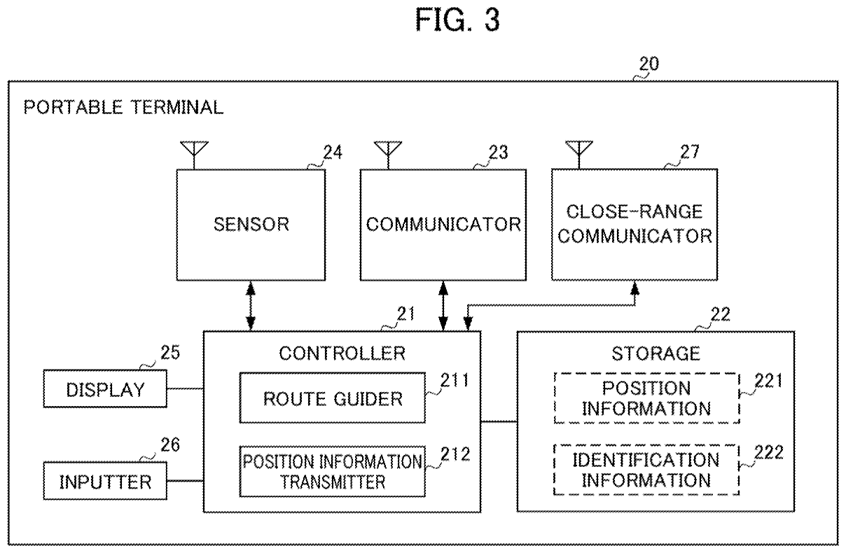

Next, the functional blocks of the portable terminal 20 will be described with reference to the block diagram of FIG. 3.

Here, while the on-board navigation device 10 described above is supplied with power from the vehicle 60a, the portable terminal 20 is supplied with power from its own battery (not illustrated). However, the portable terminal 20 may be supplied with power from a cigar lighter socket or the like of the vehicle 60b in order to charge the battery.

As illustrated in FIG. 3, the portable terminal 20 includes a controller 21, a storage 22, a communicator 23, a sensor 24, a display 25, an inputter 26, and a close-range communicator 27.

Here, the controller 21, the storage 22, the communicator 23, the sensor 24, the display 25, and the inputter 26 have the same functions as the functional blocks with the same names of the on-board navigation device 10 described above. In other words, the functional blocks of the portable terminal 20 can be described by replacing the term “on-board navigation device 10” with the term “portable terminal 20” in the above description of the on-board navigation device 10; therefore, redundant descriptions are omitted.

On the other hand, the portable terminal 20 differs from the on-board navigation device 10 in that the portable terminal 20 includes the close-range communicator 27, so this difference will be described below.

The close-range communicator 27 is a unit for performing contactless close-range communication according to standards such as Near Field Communication (NFC) and Bluetooth®, or wired close-range communication through a Universal Serial Bus (USB) cable or the like.

Meanwhile, the vehicle 60b includes a close-range communicator for communicating with the close-range communicator 27. For example, an Electronic Control Unit (ECU) of the vehicle 60b includes a close-range communicator.

As such, a case in which the portable terminal 20 is capable of communicating with the ECU through close-range communication is thus a case in which the portable terminal 20 is present in the interior of the vehicle 60b. In this case, position information measured by the sensor 24 of the portable terminal 20 corresponds to the position information of the vehicle 60b.

While the portable terminal 20 is capable of close-range communication with the ECU via the close-range communicator 27, the portable terminal 20 activates a position information transmitter 212. The activated position information transmitter 212, like the position information transmitter 112 of the on-board navigation device 10, transmits position information 221 for identifying a movement route of the vehicle 60b measured by the sensor 24 and identification information 222 to the information analysis device 30.

For example, when the user holding the portable terminal 20 gets in the vehicle 60b and turns on the activation switch such as the ignition switch of the vehicle 60b, the vehicle 60b and the portable terminal 20 are connected (paired), and the position information 221 measured by the portable terminal 20 and the identification information 222 are transmitted from the portable terminal 20 to the information analysis device 30. In this case, a position that is identified by the position information 221 measured immediately after pairing of the vehicle 60b and the portable terminal 20 may be transmitted to the information analysis device 30 as an initial vehicle position, i.e., a departure position.

Further, when the activation switch such as the ignition switch of the vehicle 60b is turned off, the pairing of the vehicle 60b and the portable terminal 20 is disconnected. In this case, a position that is identified by the position information 221 measured immediately before disconnection may be transmitted to the information analysis device 30 as a final vehicle position, i.e., a parking position.

In this case, as in the case of the position information 112, information may be transmitted in real time or using burst transmission, burst transmission may be switched to real-time transmission when it has been determined that the parking position has been reached, activation information or stopping information may be added to indicate that the vehicle is at the departure position or the parking position, and the parking position may be transmitted at a time of re-activation.

Moreover, in a case of the vehicle 60b having a function of measuring position information, the position information measured by the vehicle 60b may be transmitted as the position information 221 to the information analysis device 30 instead of the position information measured by the sensor 24. In this case, the sensor 24 may be omitted from the portable terminal 20.

### <Functional Blocks of Information Analysis Device 30>

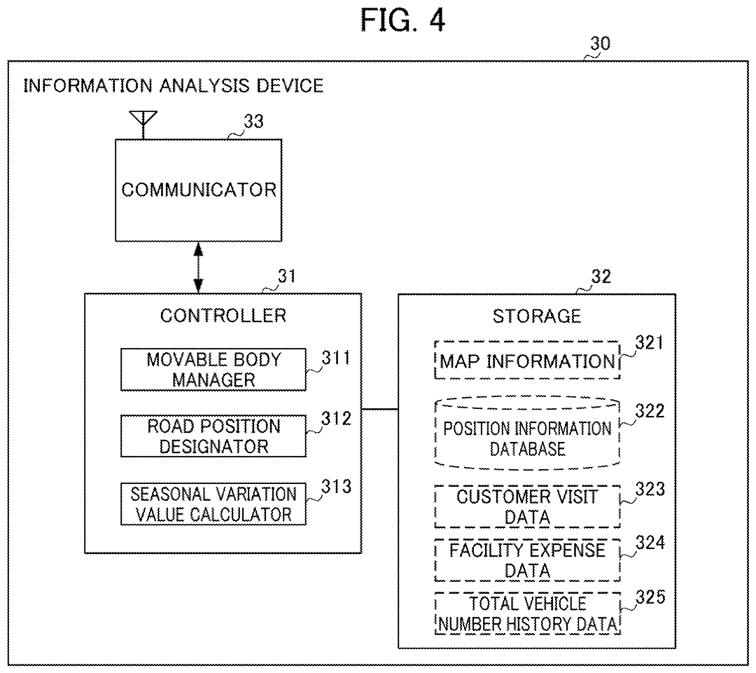

Next, the functional blocks of the information analysis device 30 will be described with reference to the block diagram of FIG. 4.

As illustrated in FIG. 4, the information analysis device 30 includes a controller 31, a storage 32, and a communicator 33.

The controller 31 is constituted by a processing device such as a microprocessor and controls each component constituting the information analysis device 30. The details of the controller 31 will be described later.

The storage 32 is constituted by semiconductor memory or the like, and stores various programs such as a control program called firmware or an operating system and a program for performing an information analysis process, and further stores various kinds of information such as map information, etc. The drawing illustrates, as information stored by the storage 32, map information 321, a position information database 322, customer visit data 323, facility expense data 324, and total vehicle number history data 325.

The map information 321 includes information such as information on features like a road and a facility, road information, facility position information, parking lot position information, and the like. In addition, the map information 321 also includes display map data for displaying backgrounds such as a road and a road map, position information of nodes (for example, an intersection, a bend point, an end point, and the like of a road) and type information thereof, position information of a link that is a route connecting respective nodes and type information thereof, and road network data including link cost data relating to cost information of all links (for example, a distance, required time, and the like), etc.

Information of a so-called road map such as a position and shape of a road, the type of the road, positions of traffic signals, etc. is stored as the road information.

Position information of each facility is stored in the form of latitude and longitude information as the facility position information. In addition, the facility position information may include additional information of a facility, such as identification information (facility ID), name, facility type (and/or genre), telephone number, address, business hours, menu provided if the facility is a restaurant, facility information relating to goods and services, etc.

Position information of a parking lot is stored in the form of latitude and longitude as the parking lot information. When a parking lot is a parking lot of a respective facility, the facility and the parking lot are stored in association with each other.

The map information 321 may be stored in the storage 32 in advance, or downloaded as necessary from a server device (not illustrated) or the like connected to the communication network 50. Further, the information may be modified as necessary in response to an input from the user, etc.

The position information database 322 is a database constructed based on the position information 121 and the identification information 122, and the position information 221 and the identification information 222, received respectively from the on-board navigation device 10 and the portable terminal 20. The position information database 322 is constructed by a movable body manager 311 described later. The details of the position information database 322 will be described later when describing the movable body manager 311. It should be noted that in the following description, when providing a description without making any distinction between the position information 121 and the position information 221, the reference numerals are omitted, and the information is referred to as “position information”. In addition, when providing a description without making any distinction between the identification information 122 and the identification information 222, the reference numerals are omitted, and the information is referred to as “identification information”.

The customer visit data 323 is data relating to customer visits to a facility such as a store or the like. Specifically, this data relates to, for example, the sales amount and number of visits (that is, the number of visitors) of a certain facility. This data is stored for a predetermined period unit such as one year, one day or one hour. In addition, this data is stored for the respective stores subject to analysis. For example, the sales amount of store A on a certain day, and the number of visits of store B in a certain hour are stored. In addition, data relating to a number of visits by movable bodies to the store may be used instead of the number of visits.

The facility expense data 324 is data relating to operating expenses of a facility. Specifically, this data relates to, for example, the rent, the lighting and heating expenses, and the personnel expenses of a certain facility. This data, similarly to the customer visit data 323, is stored for a predetermined period unit such as one year, one day or one hour. In addition, similarly to the customer visit data 323, this data is stored for the respective stores subject to analysis. For example, the rent for January of store A, and the lighting and heating expenses for a certain month of store B are stored.

The total vehicle number history data 325, similar to the customer visit data 323 and the facility expense data 324, is historical data relating to the total number of vehicles 60 (the number of vehicles including repetitions) that have passed by on each road corresponding to the respective store that is subject to analysis, on the basis of the map information 321 and the respective information stored in the position information database 322. The total vehicle number history data 325, similarly to the customer visit data 323 and the facility expense data 324, is stored for a predetermined period unit such as one year, one day or one hour. The total vehicle number history data 325 will be described later.

The customer visit data 323 and the facility expense data 324 are appropriately updated by a user. In addition, the customer visit data 323 and the facility expense data 324 may be included in the analysis condition. In other words, the user may include the customer visit data 323 and the facility expense data 324 when requesting analysis information.

It should be noted that the customer visit data 323 and the facility expense data 324 here are merely examples, and may include other data. That is to say, they may include any data as data used for the analysis by the information analysis device 30.

The communicator 33 has a digital signal processor (DSP) or the like, and realizes wireless communication with other devices via the communication network 50 according to standards such as Long Term Evolution (LTE), 4G, 5G, or Wi-Fi®. The communicator 33 is used, for example, to receive the position information and the identification information transmitted from the on-board navigation device 10 and the portable terminal 20. In addition, the communicator 33 may also be used, for example, to receive the analysis condition transmitted from the analysis information reference device 40. Further, the communicator 33 may also be used, for example, to transmit the analysis information to the analysis information reference device 40.

However, there is no particular limitation on data transmitted and received between the communicator 33 and other devices, and information other than this information may be transmitted and received.

Next, the details of the controller 31 will be described. The controller 31 is constituted by a microprocessor having a central processing unit (CPU), a random-access memory (RAN), a read-only memory (ROM), an input/output (I/O), and the like. The CPU executes each program read out from the ROM or the storage 32, reads out information from the RAM, the ROM, and the storage 32 upon execution of the program, writes the information in the RAM and the storage 32, and transmits and receives a signal to and from the communicator 33, a sensor 34, a display 35, and an input 36. Thus, the processing of the present embodiment is realized by hardware and software (programs) cooperating in this way.

The controller 31 includes, as functional blocks, a movable body manager 311, a road position designator 312, and a seasonal variation value calculator 313.

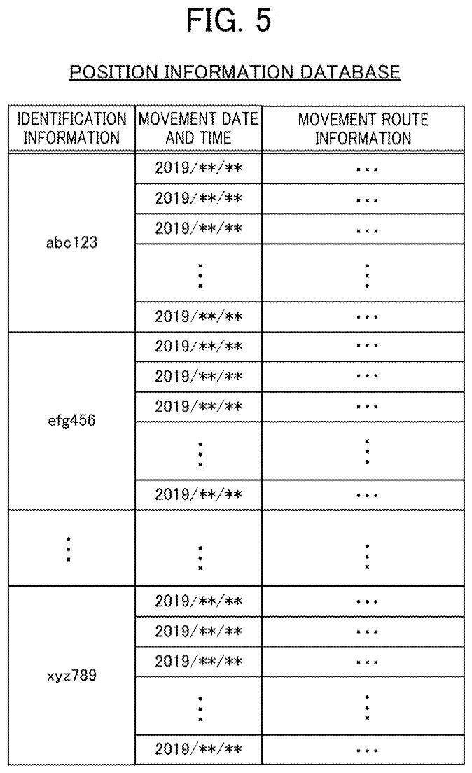

The movable body manager 311 is a section that accumulates a history of the total number of vehicles 60 (the number of vehicles including repetitions) that have passed by on each road corresponding to the respective store that is subject to analysis and position information received from the vehicles 60, constructs the position information data base 322 and the total vehicle number history data 325, and appropriately updates the position information database 322 and the total vehicle number history data 325. An example of the data structure of the position information database 322 will be described with reference to FIG. 5. It should be noted that, in the following description, unless it is particularly stated otherwise, the vehicles 60 refer to probe vehicles.

As illustrated in FIG. 5, the position information database 322 includes the “identification information” respectively received from the on-board navigation device 10 and the portable terminal 20 as described above. Further, the position information database 322 includes, as attributes, a “movement date and time” and “movement route information” identified by the movable body manager 311 based on the “position information” respectively received from the on-board navigation device 10 and the portable terminal 20 as described above. The movable body manager 311 constructs and updates the position information database 322 by storing the information corresponding to the respective attributes in fields as a set of the movement date and time and the movement route information for each piece of identification information.

The “identification information” in the position information database 322 is information for identifying the on-board navigation device 10 or the portable terminal 20 from which the position information was transmitted as described above. That is to say, it is information for identifying the vehicle 60 corresponding to the on-board navigation device 10 or the portable terminal 20.

The “movement date and time” in the position information database 322 is information indicating the date and time at which the vehicle 60 corresponding to the identification information moved. In the present embodiment, one movement is considered to be, for example, a duration from when transmission of position information from any on-board navigation device 10 or portable terminal 20 started until the transmission ends. A date and time corresponding to this one movement is stored as the movement date and time in the position information database 322.

The “movement route information” in the position information database 322 includes position information about the latitude and longitude, etc. of the vehicle 60 from the GPS sensor which changes in a time-discrete manner received during one movement, and road route information indicating a road route identified on the basis of the position information and the road information of the map information 321. The movable body manager 311 can identify the road route of the vehicle 60 by connecting the position information that changes in a time-discrete manner and combining the position information with the road information of the map information 321. When the accuracy of the position information is low in the environment in which the present embodiment is implemented, the movable body manager 311 may be configured to perform map matching in order to identify the road route. However, if the accuracy of the position information is high, map matching may not be absolutely necessary.

Whenever transmission of position information and identification information from any on-board navigation device 10 or portable terminal 20 is started and then ended, the movable body manager 311 stores each piece of information described above in a new field on the basis of the received position information and identification information to create/update the position information database 322.

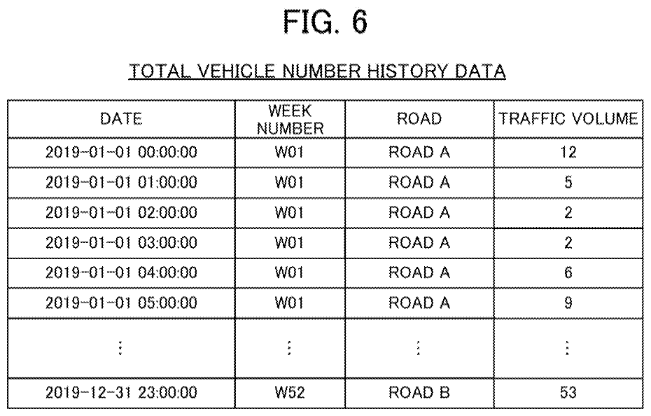

FIG. 6 illustrates an example of the total vehicle number history data 325. The total vehicle number history data 325 illustrated in FIG. 6 is, for example, data indicating the total number of vehicles 60 for each road during a one-hour period unit.

As illustrated in FIG. 6, the total vehicle number history data 325 includes, as attributes, “date”, “week number”, “road”, and “traffic volume”.

The “date” in the total vehicle number history data 325 is information indicating a date and time at which accumulation by the movable body manager 311 was started on the basis of the “movement date and time” in the position information database 322. In the present embodiment, the movable body manager 311 generates the total vehicle number history data 325 illustrated in FIG. 6 using, for example, data for the year 2019 in the position information database 322.

The “week number” in the total vehicle number history data 325 indicates a week number based on the IS08601 standard. It should be noted that the actual week numbers W01 to W52 of 2019 are from Dec. 31, 2018 to Dec. 29, 2019, but in FIG. 6, the week number for Dec. 30 and Dec. 312019 is indicated as “W52”.

The “road” in the total vehicle number history data 325 is information indicating a link including a road position designated by a user of the analysis information reference device 40 described later. The “road A” that is a designated road position is a road that is adjacent to, for example, the entrance to a store (facility) A or a parking lot of the store (facility) A. In addition, the “road B” that is a designated road position is a road that is adjacent to, for example, the entrance to a store (facility) B or a parking lot of the store (facility) B. When the store A and the store B have a plurality of entrances or parking lots, a plurality of roads may be identified.

The “traffic volume” in the total vehicle number history data 325 is the total number of vehicles 60 (the number of vehicles including repetitions) that have passed by on each road indicated by the “road” in the total vehicle number history data 325 during each one-hour period indicated by the “date” in the total vehicle number history data 325, on the basis of the “movement date and time” and the “movement route information” in the position information database 322.

When the information analysis device 30 has received analysis information from the analysis information reference device 40 described later, the movable body manager 311 creates the total vehicle number history data 325 on the basis of the store, the road, and the analysis period, etc. instructed in the analysis information, and the movement date and time and the road route information included in the movement route information in the position information database 322.

The road position designator 312 is a section that receives a designation of a road position of the map information by a user of the analysis information reference device 40 described later. The road position designator 312 may receive one designated road position, or a plurality of two or more.

Then, the road position designator 312 outputs the designated road position to the seasonal variation value calculator 313 described later.

The seasonal variation value calculator 313 calculates, for the designated road position, a seasonal variation value of the number of vehicles 60 that actually pass the road position (the total number of vehicles) from the position information of a plurality of vehicles 60, by calculating a vehicle number increase/decrease correction value for a predetermined period from the total vehicle number history data 325, and taking the vehicle number increase/decrease correction value into account.

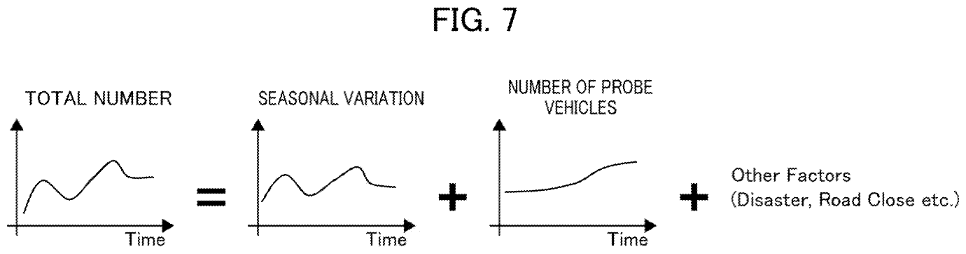

Here, among the vehicles 60 traveling on the road, the proportion of vehicles in which the on-board navigation device 10 is used and vehicles in which the portable terminal 20 is used varies. In other words, as illustrated in FIG. 7, the total vehicle number of the vehicles 60 that have their position information measured in the position information database 322 is the sum of the seasonal variation component of the total number of vehicles 60, the variation component of the number of vehicles 60 in which the on-board navigation device 10 or the portable terminal 20 are used, and other components such as disasters, road closures, etc.

Thus, the seasonal variation value calculator 313 calculates the variation component of the vehicles 60 in which the on-board navigation device 10 or the portable terminal 20 are used as the vehicle number increase/decrease correction value and, using the calculated vehicle number increase/decrease correction value, obtains the seasonal variation component among the variations of the total vehicle number of the measured vehicles 60 as the seasonal variation value of the vehicle number (total number of vehicles) of the vehicles 60. In the below description, the other components in FIG. 7 are included in the seasonal variation component, because separating the components would be difficult.

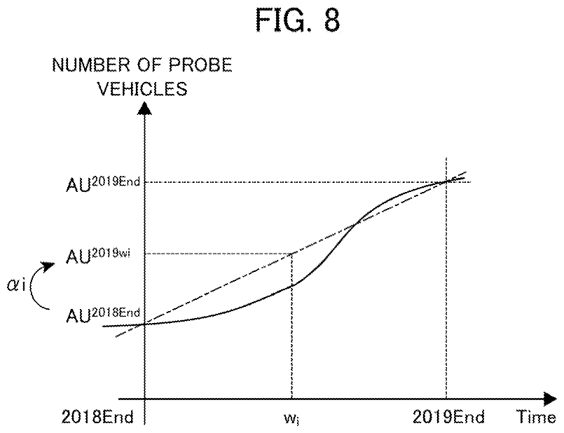

FIG. 8 illustrates an example of variations in the number of vehicles 60 in which the on-board navigation device 10 and the portable terminal 20 are used.

As illustrated in FIG. 8, for example, in a period from Dec. 31, 2018 (also referred to as “2018End” below) to Dec. 31, 2019 (also referred to as “2019End” below), the vehicle number of vehicles 60 in which the on-board navigation device 10 or the portable terminal 20 are used increases as indicated by the solid line. The seasonal variation value calculator 313 approximates the vehicle number of the vehicles 60 in which the on-board navigation device 10 or the portable terminal 20 are used in the period from 2018End to 2019End as a straight line, as indicated by the dashed line, using a mathematical formula 1.

$${AU}^{2019 {w}_{i}} = {α}_{weekly} \cdot {w}_{i} + {AU}^{2018 End} \\ ( {α}_{weekly} = \frac{{AU}^{2019 End} - {AU}^{2018 End}}{{52}_{weeks}} ) \qquad [ Math 1 ]$$

AU^{2018End} indicates the number of vehicles 60 in which the on-board navigation device 10 or the portable terminal 20 are used during Dec. 312018. AU^{2019End} indicates the vehicle number of vehicles 60 in which the on-board navigation device 10 or the portable terminal 20 are used on Dec. 31, 2019. wᵢ indicates a week number, and AU^{2019wi} indicates the vehicle number of vehicles 60 in which the on-board navigation device 10 or the portable terminal 20 are used during week number wᵢ of 2019.

Then, using mathematical formula 2, the seasonal variation value calculator 313 calculates the ratio of AU^{2019wi} to AU^{2018End} as a vehicle number increase/decrease correction value αᵢ indicating variation components of the vehicle number of vehicles 60 in which the on-board navigation device 10 or the portable terminal 20 are used during week number wᵢ.

$${α}_{i} = \frac{{AU}^{2019 {w}_{i}}}{{AU}^{2018 End}} = 1 + \frac{{α}_{weekly}}{{AU}^{2018 End}} \cdot {w}_{i} \qquad [ Math 2 ]$$

The seasonal variation value calculator 313 calculates the seasonal variation value of the vehicle number of the vehicles 60 (the total number of vehicles) as a corrected traffic volume, by dividing the total vehicle number of the vehicles 60 measured at the designated road position by, for example, the vehicle number increase/decrease correction value αᵢ for each week number wᵢ.

The advantage of calculating the seasonal variation value on a weekly basis is as follows. With a seasonal variation value based on one day, there may be a great difference between weekdays and holidays, and with a seasonal variation value based on one month, the number of days will vary from 28 to 31, and the number of weekends will differ depending on the year. On the other hand, with a seasonal variation value based on one week, the number of weekends will always be the same, and the influence of consecutive holidays such as Golden Week or the like can be included, allowing for the prediction of sales, etc. regardless of the variation between weekdays and holidays.

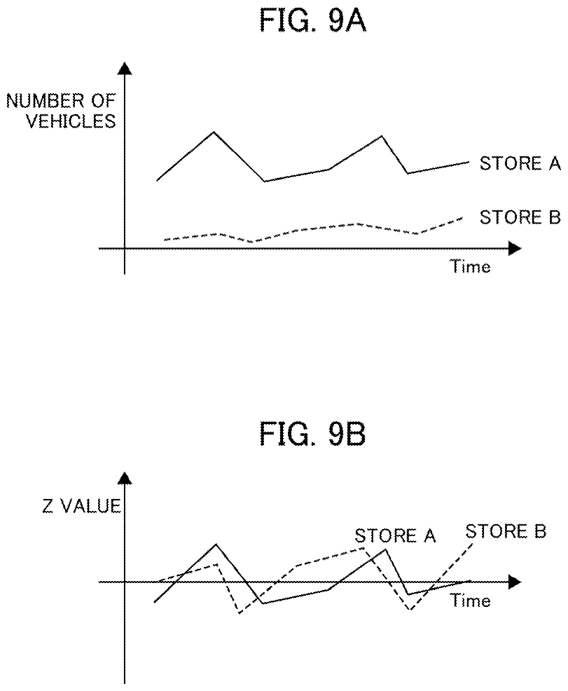

In addition, when, for example, the user of the analysis information reference device 40 described later has designated a store A and a store B (or roads respectively corresponding to the store A and the store B), an analysis condition regarding variations of the total vehicle numbers of vehicles 60 that have passed the roads respectively corresponding to the store A and the store B has been received, and the seasonal variation values of the vehicle numbers (total number of vehicles) of the vehicles 60 that have passed the roads respectively corresponding to the designated stores A and B are to be compared, the information analysis device 30 may have difficulties determining which of the stores has the greater seasonal variation value of the vehicle number (total vehicle number) of the vehicles 60, as illustrated in FIG. 9A.

That is to say, as illustrated in FIG. 9A, when there is a great difference between the absolute number of the total number of the vehicles 60 that have passed the road corresponding to the store A, and the absolute number of the total number of the vehicles 60 that have passed the road corresponding to the store B, it is difficult to determine which of the stores has the greater seasonal variation value of the vehicle number (total number of vehicles) of the vehicles 60.

The seasonal variation value calculator 313 thus evaluates the seasonal variation values of the vehicle numbers (total number of vehicles) of the vehicles 60 by a Z value (standardization score), using mathematical formula 3.

$${z}_{i , k} = \frac{{X}_{i , k} - 〈 {X}_{k} 〉}{{σ}_{k}} \qquad [ Math 3 ]$$

X_{i,k} indicates the seasonal variation value of the vehicle number (total number of vehicles) of the vehicles 60 during a month i of a road corresponding to a store k (where i is 1 to 12). <Xₖ> indicates an average value of the seasonal variation value of the vehicle number (total number of vehicles) of the vehicles 60 that have passed the road corresponding to the store k. σₖ indicates the standard deviation of the seasonal variation value of the vehicle number (total number of vehicles) of the vehicles 60 that have passed the road corresponding to the store k. That is to say, the Z value (standardization score) is an index indicating by how many standard deviations the value of the seasonal variation value of the vehicle number (total number of vehicles) of the vehicles 60 is separated from the average value thereof, and is a dimensionless number. The Z value (standardization score) is a positive value when greater than the average value, and is a negative value when smaller than the average value.

FIG. 9B illustrates an example of a graph of the Z value.

As illustrated in FIG. 9B, by using the Z value, the high and low seasonal variation values of the vehicle numbers (total number of vehicles) of the vehicles 60 between the store A and the store B can be compared regardless of the difference in n number.

It should be noted that a Z value based on a unit of one month is used in FIG. 9A and FIG. 9B, but the value can be obtained in the same way using a Z value based on a unit such as one week.

### <Functional Blocks of Analysis Information Reference Device 40>

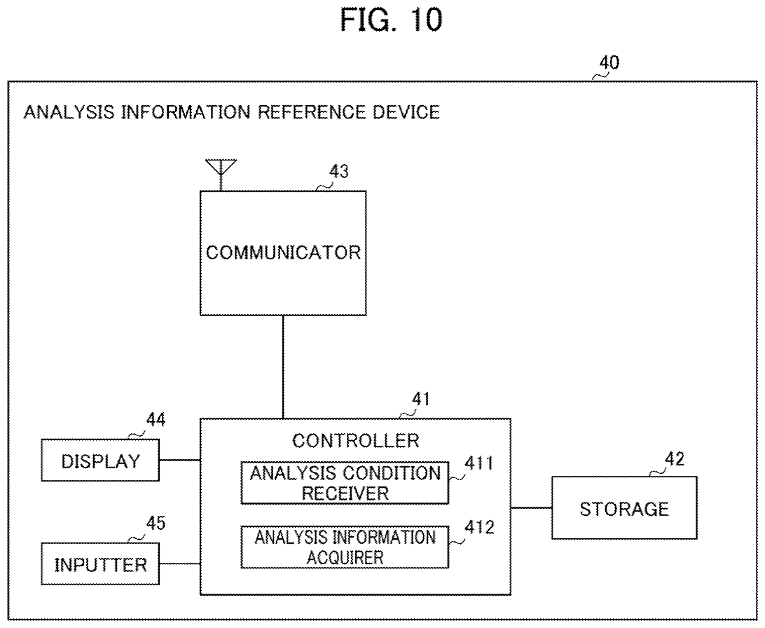

As illustrated in FIG. 10, the analysis information reference device 40 includes at least a controller 41, a storage 42, a communicator 43, a display 44, and an inputter 45. The configuration of each unit is the same as the respective units with the same names in, for example, the on-board navigation device 10 and the portable terminal 20.

The controller 41 includes an analysis condition receiver 411 and an analysis information acquirer 412. The analysis condition receiver 411 generates a user interface for receiving an input operation of an analysis condition from the user, and causes the display 44 realized by a display to display the generated user interface. The user of the analysis information reference device 40 refers to the user interface and inputs the analysis condition using the inputter 45, which receives inputs from an input interface such as a keyboard or mouse, etc. The communicator 43 transmits the analysis condition to the information analysis device 30. In addition, analysis information generated on the basis of the analysis condition is received from the information analysis device 30.

The received analysis information is acquired by the analysis information acquirer 412. The analysis information acquirer 412 outputs the acquired analysis information. The method for outputting may include, for example, causing the display 44 to display the information, and transmitting the information as electronic data to an external device.

This allows the user of the analysis information reference device 40 to refer to the contents of the analysis information.

### <Specific Example of Display Corresponding to Analysis Information>

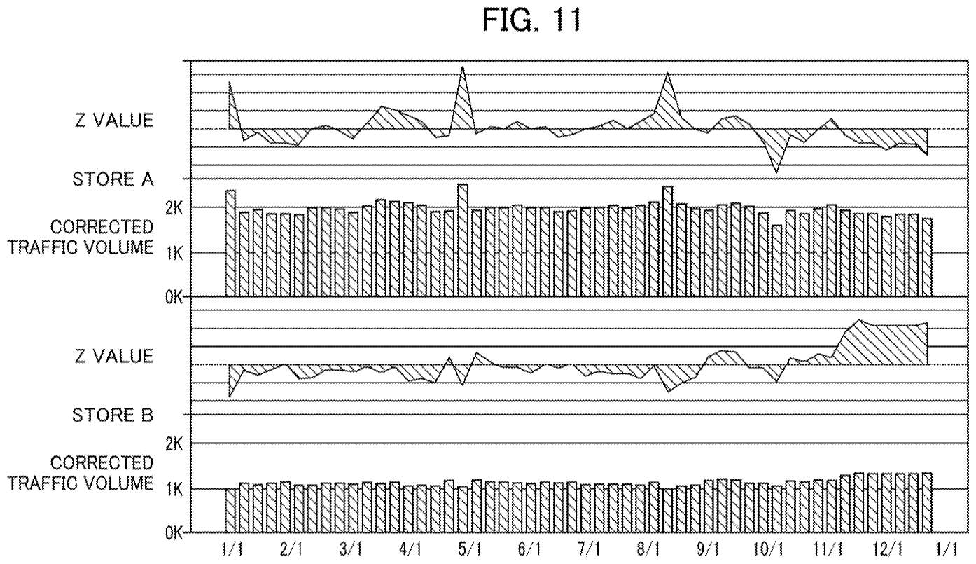

Next, a specific example corresponding to a display corresponding to the analysis information will be described with reference to FIG. 11.

The specific example exemplifies displaying the variation in the total number of vehicles 60 that have passed roads respectively corresponding to two stores.

For example, when the user of the analysis information reference device 40 has designated roads respectively corresponding to a store A and a store B, and an analysis condition regarding the seasonal variations of the vehicle numbers (total number of vehicles) of vehicles 60 that have passed the roads respectively corresponding to the store A and the store B has been received, the information analysis device 30 generates a graph comparing the seasonal variations of the vehicle numbers (total number of vehicles) of the vehicles 60 that have passed the roads respectively corresponding to the designated store A and the store B.

FIG. 11 illustrates an example of a display of the Z values and the seasonal variation values of the vehicle numbers (total number of vehicles) of the vehicles 60 that have passed the roads respectively corresponding to the store A and the store B. The upper part of FIG. 11 indicates the Z value and the seasonal variation value of the vehicle number (total number of vehicles) of the vehicles 60 of the store A, and the lower part of FIG. 11 indicates the Z value and the seasonal variation value of the vehicle number (total number of vehicles) of the vehicles 60 of the store B. The Z values and the seasonal variation values in FIG. 11 are calculated on the basis of the total vehicle number history data 325 collected on a weekly basis in the year 2019. In FIG. 11, the seasonal variation values are indicated as corrected traffic volumes.

By referring to a display such as that illustrated in FIG. 11, the user of the analysis information reference device 40 can visually grasp the variations in the Z values and the corrected traffic volumes of the vehicle numbers (total number of vehicles) of the vehicles 60 of the store A and the store B. For example, as illustrated in FIG. 11, the Z value and the corrected traffic volume for the store A increased during Golden Week and the Obon holiday; whereas, the Z value and the corrected traffic volume for the store B decreased during Golden Week and the Obon holiday. Meanwhile, the Z value and the corrected traffic volume for the store A decreased during the end of the year; whereas, the Z value and the corrected traffic volume for the store B increased during the end of the year. Based on this, the user can grasp that the trends during Golden Week, the Obon holiday, and the end of the year are inverted between the store A and the store B.

In addition, when a typhoon came on Oct. 12, 2019, the Z values and the corrected traffic volumes for both the store A and the store B decreased, from which the user can grasp that the trends for the store A and the store B were the same.

In other words, by referring to a display such as that illustrated in FIG. 11, the user of the analysis information reference device 40 can visually grasp the Z values and the corrected traffic volumes of the vehicle numbers (total number of vehicles) of the vehicles 60 that have passed the roads respectively corresponding to the store A and the store B.

In addition, as illustrated in FIG. 11, for the store A and the store B, there are periods in which the Z value is a positive value (that is, when the total number of the vehicles 60 that have passed the roads respectively corresponding to the store A and the store B is above the average value), and periods in which the Z value is a negative value (that is, when the total number of the vehicles 60 that have passed the roads respectively corresponding to the store A and the store B is below the average value). In other words, the respective sales of the store A and the store B vary according to an increase or decrease in the total number of the vehicles 60 that have passed the roads.

For example, when the user of the analysis information reference device 40 has designated the road corresponding to the store A, and the information analysis device 30 has received an analysis condition regarding a correlation between the vehicle number (total number of vehicles) of the vehicles 60 that have passed the road corresponding to the store A and the customer visits to the store A or the sales, the seasonal variation value calculator 313 may calculate the Z value and the seasonal variation value (corrected traffic volume) of the vehicle number (total number of vehicles) of the vehicles 60 that have passed the road corresponding to the store A, on the basis of the various information stored in the storage 32 described above, and calculate the correlation between the Z value or the seasonal variation value (corrected traffic volume) of the calculated vehicle number (total vehicle number) of the vehicles 60 and the customer visits to the store A or the sales.

Specifically, the seasonal variation value calculator 313 calculates, for example, the Z value and the seasonal variation value (corrected traffic volume) of the vehicle number (total number of vehicles) of the vehicles 60 that have passed the road corresponding to the store A during a predetermined period unit of one week, etc., on the basis of various information stored in the storage 32. The seasonal variation value calculator 313 obtains a correlation between the calculated Z value (or the corrected traffic volume) and the number of visits to the store A or the sales amount stored in the customer visit data 323, and generates the obtained correlation as analysis information corresponding to the analysis condition. The seasonal variation calculator 313 transmits the generated analysis information to the analysis information reference device 40.

It should be noted that the display method illustrated in FIG. 11 is merely an example, and that the display method according to the present embodiment is not limited to this example.

### <Example of Use by User of Display Corresponding to Analysis Information>

Next, a method for the user to use the analysis information displayed in this way will be described.

The user may use this analysis information for a variety of applications. For example, the user is able to perform an analysis of variations in the sales amount and number of visitors of a store based on the Z value and the seasonal variation value of the vehicle number (total number of vehicles) of the vehicles 60. Thus, by using the analysis information, variations in the sales and the number of visitors can be precisely ascertained.

For example, by using the Z value or the seasonal variation value of the vehicle number (total number of vehicles) of vehicles 60 calculated for a certain store, and the Z value or the seasonal variation value of the vehicle number (total number of vehicles) of vehicles 60 for another store that is in a similar surrounding environment to that of the certain store, the variations in the sales amount and the number of visitors for the certain store can be predicted. In addition, using the analysis information also makes it possible to precisely ascertain variations in the sales amount, etc. of another store that is in a competitive relationship.

Thus, the user is able to make store opening plans, etc. using the analysis information. Conventionally, store opening plans have been made according to the experience, etc. of a consultant; however, with the analysis information according to the present embodiment, store opening plans can be made on the basis of an objective standard, unlike such subjective information as an individual's experience, etc.

In this case, the user may be a business operator who is considering opening a new store, or a consultant who is providing consulting services to the business operator. In other words, the analysis information according to the present embodiment may be used by a variety of users.

In addition, the user may perform other analyses using the analysis information. For example, an analysis may be performed to determine whether or not a store is affected by the traffic volume of cars. For another example, when the user is a business operator operating a chain of businesses in a wide area such as the entire country, the traffic volume correlation of each major road in the country can be known on the basis of analysis information of each store.

Then, in cases where the correlation is weak, i.e., when the vehicle number (total number of vehicles) of vehicles 60 is high but does not lead to visits, consideration may be made to the size of parking lots, availability of bicycle parking lots, advertising methods, etc.

The user is also able to consider variable elements for which a correlation cannot be obtained, such as, for example, whether there are any facilities such as schools or event spaces in the vicinity. Consideration may also be made to other variable elements such as traffic congestion, weather, temperature, day of the week, etc.

In addition, calculating the correlation for, for example, a time period allows for analysis such as the correlation being strong during the daytime but weak during the nighttime. Consideration may thus be made to, for example, the fact that a sign may not be visible during nighttime, etc.

These are merely examples, and the analysis information may be used for other applications. That is to say, the analysis information according to the present embodiment may be advantageously used for a variety of applications by a variety of users such as business operators and consultants.

### Operation of the Present Embodiment

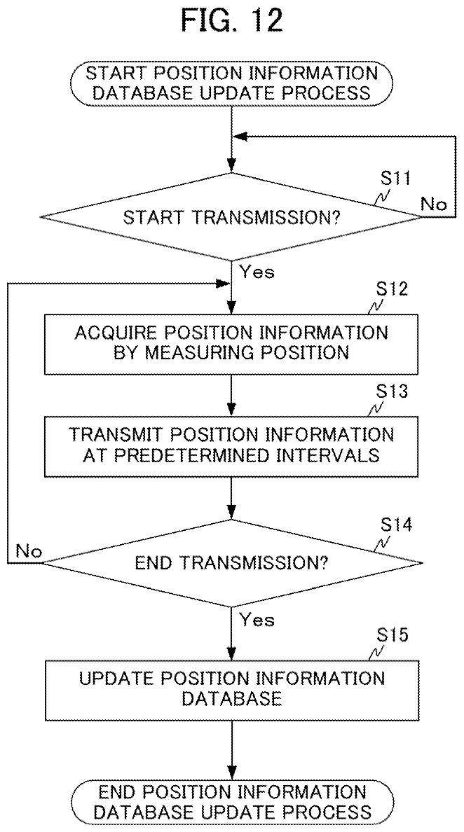

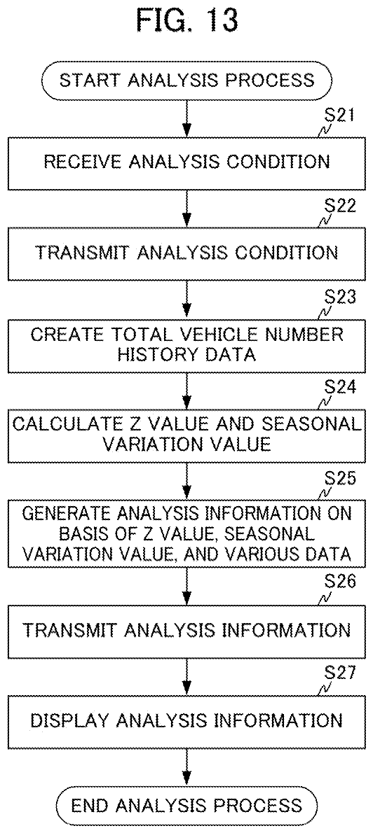

Next, an operation of the present embodiment will be described with reference to the flowcharts in FIG. 12 and FIG. 13. Here, FIG. 12 is a flowchart illustrating operation during collection of position information and updating of the position information database 322. FIG. 13 is a flowchart illustrating operation during information analysis processing.

First, an operation of updating the position information database 322, accompanying the collection of position information regarding the on-board navigation device 10, will be described with reference to FIG. 12.

The position information transmitter 112 determines whether or not to start transmission of the position information (Step S11). As described above, the transmission is started when the ignition switch of the vehicle 60a has been turned on. If the ignition switch is still turned off (No in Step S11), transmission by the position information transmitter 112 is not started. On the other hand, if the ignition switch has been turned on (Yes in Step S11), the processing advances to Step S12.

In Step S12, the sensor 14 acquires the position information by measuring the position of the on-board navigation device 10 (Step S12).

The position information transmitter 112 acquires the position information from the sensor 14 and transmits the acquired position information to the information analysis device 30 at predetermined intervals in real time or by burst transmission (Step S13).

Next, the position information transmitter 112 determines whether or not to end transmission of position information (Step S14). As described above, the transmission ends if the ignition switch of the vehicle 60a has been turned off. If the ignition switch of the vehicle 60a remains turned on (No in Step S14), the measuring in Step S12 and the transmission in Step S13 are repeated.

On the other hand, if the ignition switch of the vehicle 60a has been turned off (Yes in Step S14), the processing advances to Step S15.

In Step S15, the movable body manager 311 of the information analysis device 30 updates the position information database 322 on the basis of the position information transmitted by the repetition of Step S12 and Step S13 (Step S15).

The operation described above realizes collection of position information and updating of the position information database.

Next, an operation of collecting position information regarding the portable terminal 20 and updating the position information database will be described. In regards to the portable terminal 20, in the above description, it is sufficient to simply replace the position information transmitter 112 with the position information transmitter 212, the sensor 14 with the sensor 24, the criteria for Yes in Step S11 to “if the activation switch such as the ignition switch of the vehicle 60b is turned on and the vehicle 60b and the portable terminal 20 are paired”, and the criteria for Yes in Step S14 to “if the activation switch such as the ignition switch of the vehicle 60b has been turned off and the pairing between the vehicle 60b and the portable terminal 20 has been disconnected”. Accordingly, redundant descriptions are omitted.

Next, an operation of performing the analysis process will be described with reference to FIG. 13.

First, the analysis condition receiver 411 of the analysis information reference device 40 receives an analysis condition including a store or a road and an analysis period, etc. designated by a user via the inputter 45 (Step S21).

Then, the analysis condition receiver 411 transmits the received analysis condition to the information analysis device 30 (Step S22).

The movable body manager 311 creates the total vehicle number history data 325 on the basis of the store or the road and the analysis period, etc. designated in the analysis information received from the analysis information reference device 40, and the movement date and time and the road route information included in the movement route information in the position information database 322 (Step S23).

The seasonal variation value calculator 313 calculates the Z value and the seasonal variation value of the vehicle number (total number of vehicles) of the vehicles 60 that have passed the road corresponding to the store designated in Step S22, on the basis of the total vehicle number history data 325 created in Step S23 (Step S24).

Next, the seasonal variation value calculator 313 generates the analysis information on the basis of the Z value and the seasonal variation value calculated in Step S24, the analysis condition transmitted in Step S22, and various information stored in the storage 32 (Step S25).

Furthermore, the seasonal variation value calculator 313 transmits the generated analysis information to the analysis information reference device 40 (Step S26).

The analysis information acquirer 412 of the analysis information reference device 40, having received the analysis information, causes the display 44 to display the acquired analysis information (Step S27). In this way, a display such as that described with reference to FIG. 11, for example, is made.

According to the operation of the present embodiment described above, variations in visits and sales of a store depending on the season can be precisely ascertained, based on the position information received from a plurality of vehicles 60.

### <Regarding Hardware and Software>

It should be noted that each device included in the above information analysis system can be realized by hardware, software, or a combination thereof. In addition, the information analysis method performed by a cooperation of the devices included in the above information analysis system can also be realized by hardware, software, or a combination thereof. Here, being realized by software indicates being realized by a computer reading and executing a program.

The program may be stored using various types of non-transitory computer-readable media, and may be provided to a computer. Non-transitory computer-readable media include various types of tangible storage media. Examples of non-transitory computer-readable media include magnetic storage media (e.g., flexible discs, magnetic tapes, hard disk drives), magneto-optical storage media (e.g., magneto-optical discs), CD-ROM (Read Only Memory), CD-R, CD-R/W, and semiconductor memories (e.g., mask ROM, PROM (programmable ROM), EPROM (erasable PROM), flash ROM, and RAM (random access memory)). The program may also be provided to a computer by means of various types of transitory computer-readable media. Examples of transitory computer-readable media include electrical signals, optical signals, and electromagnetic waves. Transitory computer-readable media may provide the program to a computer through wired communication paths such as electrical wires or optical fibers, or through wireless communication paths.

### Modified Example

The embodiment described above is a preferred embodiment of the present invention, but the scope of the present invention is not limited only to the above embodiment, and the present invention may be worked in forms that apply various modifications without departing from the spirit and scope of the present invention.

For example, the functional configurations of FIG. 2, FIG. 3, FIG. 4, and FIG. 10 are merely examples, and do not limit the functional configurations of the present embodiment. That is to say, it is sufficient so long as the devices have functions capable of executing the series of processes relating to the information analysis function of the present invention as a whole, and what type of functional blocks to use in order to realize these functions is not particularly limited to the examples illustrated in FIG. 2, FIG. 3, FIG. 4, and FIG. 10.

As another modified example, although the movement route information in the position information database 322 in the embodiment described above includes position information about the latitude and longitude, etc. of the vehicle 60 from the GPS sensor changing in a time-discrete manner, and road route information indicating a road route identified on the basis of the position information and the road information of the map information 321, the movement route information is not limited thereto. For example, the movement route information in the position information database 322 may include only the position information about the latitude and longitude, etc. of the vehicle 60 from the GPS sensor changing in a time-discrete manner.

In this case, when the information analysis device 30 receives the analysis information from the analysis information reference device 40, the movable body manager 311 may create road route information indicating a road route identified on the basis of the position information of the position information database 322 and the road information of the map information 321, in order to create the total vehicle number history data 325. Then, the movable body manager 311 may create the total vehicle number history data 325 on the basis of the created road route information, and a store or a road and an analysis period, etc. designated in the analysis information received from the analysis information reference device 40.

Further, as another modified example, the on-board navigation device 10 and the portable terminal 20 may be realized by other devices that do not have a route guiding function. That is to say, the route guiding function of the on-board navigation device 10 and the portable terminal 20 is not essential. In this case, the information analysis device 30 may further include a route guiding function, and route guiding may be performed by the information analysis device 30 communicating with the on-board navigation device 10 or the portable terminal 20.

Furthermore, as another modified example, although the information analysis device 30 is described as being realized by one server device or the like in the above embodiment, a distribution processing system in which respective functions of the information analysis device 30 are appropriately distributed to a plurality of servers may be employed. In addition, the respective functions of the information analysis device 30 may be realized by using a virtual server function or the like on a cloud.

Furthermore, as another modified example, the information analysis device 30 may be configured to function as the analysis information reference device 40. In other words, an inputter and a display may be provided to the information analysis device 30, such that the inputter of the information analysis device 30 receives an analysis condition from the user, and the display of the information analysis device 30 displays the analysis information. In addition, the functions of the analysis information reference device 40 may be divided into an analysis condition input device and an analysis condition reference device. It is also possible to provide one of these divided functions to the information analysis device 30.

### EXPLANATION OF REFERENCE NUMERALS

1 Information analysis system
10 On-board navigation device
11, 21, 31, 41 Controller
111, 211 Route guider
112, 212 Position information transmitter
12, 22, 32, 42 Storage
121, 221 Position information
122, 222 Identification information
13, 23, 33, 43 Communicator
14, 24 Sensor
15, 25, 44 Display
16, 26, 45 Inputter
20 Portable terminal
27 Close-range communicator
30 Information analysis device
311 Movable body manager
312 Road position designator
313 Seasonal variation value calculator
321 Map information
322 Position information database
323 Customer visit data
324 Facility expense data
325 Total vehicle number history data
40 Analysis information reference device
411 Analysis condition receiver
412 Analysis information acquirer
50 Communication network
60a, 60b Vehicle

1. An information analysis device comprising:
a movable body manager configured to accumulate a history of a total number of a plurality of movable bodies and position information received from the movable bodies;
a map information storage configured to store map information including a position of a road along which the plurality of movable bodies can pass;
a road position designator configured to accept a designation of a road position in the map information by a user; and
a seasonal variation value calculator configured to calculate, regarding the road position designated, a vehicle number increase/decrease correction value in a predetermined period from the history of the total number of the movable body manager, and calculate a seasonal variation value of the number of the movable bodies passing the road position, from the position information relating to the plurality of movable bodies, by taking into account the vehicle number increase/decrease correction value.

2. The information analysis device according to claim 1, wherein the seasonal variation value calculator calculates the seasonal variation value of the number of the movable bodies by correcting the position information of the movable bodies using a standard score.

3. The information analysis device according to claim 1, further comprising a visit data storage configured to store data regarding customer visits to a facility corresponding to the road position designated,
wherein the seasonal variation value calculator calculates a correlation regarding the customer visits to the facility or sales, using the data regarding the customer visits.

4. The information analysis device according to claim 1, wherein the seasonal variation value calculator calculates the seasonal variation value based on a unit of a predetermined period including a weekday and a holiday.

5. An information analysis method executed by a computer, the information analysis method comprising:
a movable body management step of accumulating a history of a total number of a plurality of movable bodies and position information received from the movable bodies;
a map information storage step of storing map information including a position of a road along which the plurality of movable bodies can pass;
a road position designation step of accepting a designation of a road position in the map information by a user; and
a seasonal variation value calculation step of calculating, regarding the road position designated, a vehicle number increase/decrease correction value in a predetermined period from the history of the total number of the movable body management step, and calculating a seasonal variation value of the number of the movable bodies passing the road position, from the position information relating to the plurality of movable bodies, by taking into account the vehicle number increase/decrease correction value.

6. The information analysis method according to claim 5, further comprising a visit data storage step of storing data regarding customer visits to a facility corresponding to the road position designated,
wherein the seasonal variation value calculation step includes calculating a correlation regarding the customer visits to the facility or sales, using the data regarding the customer visits.

7. The information analysis method according to claim 6, wherein the seasonal variation value calculation step includes calculating the seasonal variation value based on a unit of a predetermined period including a weekday and a holiday.
